(19) United States
(12) Patent Application Publication
(10) Pub. No.: US 2024/0029033 A1
(43) Pub. Date: Jan. 25, 2024

(54) DISPOSAL INFORMATION GENERATION APPARATUS, ARTICLE INFORMATION GENERATION APPARATUS, DISPOSAL INFORMATION GENERATION METHOD, AND PROGRAM

(71) Applicant: NEC Corporation, Minato-ku, Tokyo (JP)

(72) Inventor: Kazuya Kawakami, Tokyo (JP)

(73) Assignee: NEC Corporation, Minato-ku, Tokyo (JP)

(21) Appl. No.: 18/265,614

(22) PCT Filed: Dec. 14, 2020
(86) PCT No.: PCT/JP2020/046557

§ 371 Date: Jun. 6, 2023

(51) Int. Cl. G06Q 10/30; G06F 3/147; G06V 20/52

(52) U.S. Cl. CPC G06Q 10/30; G06F 3/147; G06V 20/52

(57) ABSTRACT

A disposal information generation apparatus (10) includes an article information acquisition unit (110) and a disposal information generation unit (120). The article information acquisition unit (110) acquires article information being information generated by using a sensor (20), and information relating to an article. The disposal information generation unit (120) generates and outputs disposal information being information relating to a site where waste coming out of the article or the article is to be disposed of, by using the article information. Thus, a person who intends to dispose of the waste or the article can recognize the site where the waste or the article is to be disposed of, by viewing the disposal information.

### TECHNICAL FIELD

The present invention relates to a disposal information generation apparatus, an article information generation apparatus, a disposal information generation method, and a program.

### BACKGROUND ART

In order to protect environment, it is necessary to sort and recover waste according to a material and the like. For example, Patent Document 1 describes generating three-dimensional image information on an outer shape of an article such as a waste home appliance by using a result acquired by capturing an image of the article from a top-surface side and a side-surface side, and determining a type of the article by using the three-dimensional image information.

### RELATED DOCUMENT

### Patent Document

Patent Document 1: Japanese Patent Application Publication No. H11-83461

### SUMMARY OF THE INVENTION

### Technical Problem

In order to sort and recover waste, it is preferable to notify a person who wishes to dispose of an article, of a disposal site according to the article. An object of the present invention is to notify a person who wishes to dispose of an article, of a disposal site according to the article.

### Solution to Problem

The present invention provides a disposal information generation apparatus including:
an article information acquisition unit that acquires article information being information generated by using a sensor, and being information relating to an article; and
a disposal information generation unit that generates and outputs disposal information being information relating to a site where the article or waste coming out of the article is to be disposed of, by using the article information.

The present invention provides an article information generation apparatus being used together with the above-described disposal information generation apparatus, including:
a sensor that generates the article information of the article placed in a predetermined area; and
a communication unit that transmits the article information to the disposal information generation apparatus.

The present invention provides a disposal information generation method including,
by a computer:
article information acquisition processing of acquiring article information being information generated by using a sensor, and being information relating to an article; and
disposal information generation processing of generating and outputting disposal information being information relating to a site where the article or waste coming out of the article is to be disposed of, by using the article information.

The present invention provides a program causing a computer to include:
an article information acquisition function of acquiring article information being information generated by using a sensor, and being information relating to an article; and
a disposal information generation function of generating and outputting disposal information being information relating to a site where the article or waste coming out of the article is to be disposed of, by using the article information.

### Advantageous Effects of Invention

According to the present invention, it is possible to notify a person who wishes to dispose of an article, of a disposal site according to the article.

### BRIEF DESCRIPTION OF THE DRAWINGS

The above-described object, other objects, features, and advantages will become more apparent from suitable example embodiments described below and the following accompanying drawings.

FIG. 1 is a diagram illustrating a usage environment of a disposal information generation apparatus according to a first example embodiment.

FIG. 2 is a diagram illustrating one example of a functional configuration of the disposal information generation apparatus.

FIG. 3 is a diagram illustrating one example of data structure of an article master storage unit.

FIG. 4 is a diagram illustrating one example of data structure of a site information storage unit.

FIG. 5 is a diagram illustrating a hardware configuration example of the disposal information generation apparatus.

FIG. 6 is a diagram illustrating one example of processing to be performed by the disposal information generation apparatus.

FIG. 7 is a diagram illustrating a usage environment of a disposal information generation apparatus according to a first modification example.

FIG. 8 is a diagram illustrating a usage environment of a disposal information generation apparatus according to a second modification example.

FIG. 9 is a diagram illustrating a usage environment of a disposal information generation apparatus according to a third modification example.

FIG. 10 is a diagram illustrating a usage environment of a disposal information generation apparatus according to a fourth modification example.

FIG. 11 is a flowchart illustrating one example of an operation of a disposal information generation apparatus according to a fifth modification example.

FIG. 12 is a diagram illustrating a usage environment of a disposal information generation apparatus according to a second example embodiment.

FIG. 13 is a diagram illustrating a modification example in FIG. 12.

### DESCRIPTION OF EMBODIMENTS

Hereinafter, example embodiments according to the present invention are described with reference to the drawings. Note that, in all drawings, a similar constituent element is indicated by a similar reference sign, and description thereof is omitted as necessary.

### First Example Embodiment

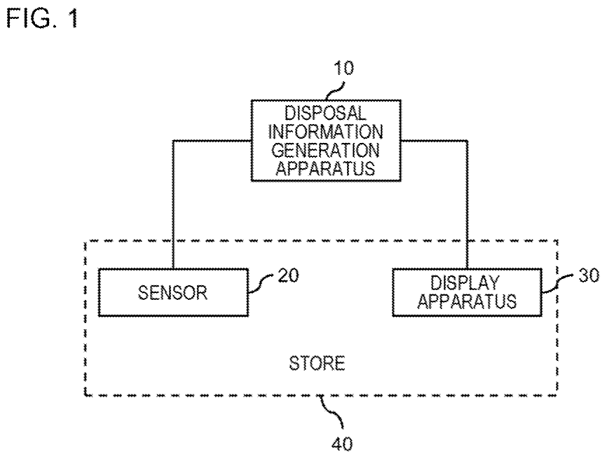

FIG. 1 is a diagram illustrating a usage environment of a disposal information generation apparatus 10 according to a present example embodiment. The disposal information generation apparatus 10 generates information indicating a disposal method of waste coming out of an article or an article (hereinafter, described as an article), for example, information (hereinafter, described as disposal information) indicating a site of disposal, and outputs the disposal information. An output destination of the disposal information is an apparatus recognizable by a person who disposes of the article.

The disposal information generation apparatus 10 is used together with a sensor 20. The sensor 20 includes, for example, at least one of an imaging apparatus, a weight sensor, an odor sensor, and a sound sensor, and is used for generating information (hereinafter, described as article information) relating to an article. The article information may be information itself generated by the sensor 20, or may be acquired by processing information generated by the sensor 20. In the latter case, the article information may be generated by the sensor 20, or may be generated by the disposal information generation apparatus 10.

In the example illustrated in FIG. 1, an article is a product sold in a store for example, food and drink. Further, the sensor 20 is, for example, an imaging apparatus, and photographs a site in the store 40, for example, a site where payment for products is performed. Further, the disposal information is output to a display apparatus 30 installed in the store 40. The display apparatus causes a purchaser of an article to recognize a site where the article is to be disposed of, by displaying the disposal information. The display apparatus 30 may be installed within a store, or may be installed outside the store (e.g., near an exit).

Note that, a site where the sensor 20 and the display apparatus 30 are installed may be outside a store, for example, in town. In this case, the sensor includes, for example, a monitoring camera. Further, the display apparatus 30 is installed near the sensor 20. By doing so, when a person who wishes to dispose of an article causes the article to be photographed by the monitoring camera (sensor 20), article information is displayed on the display apparatus 30 associated with the sensor 20.

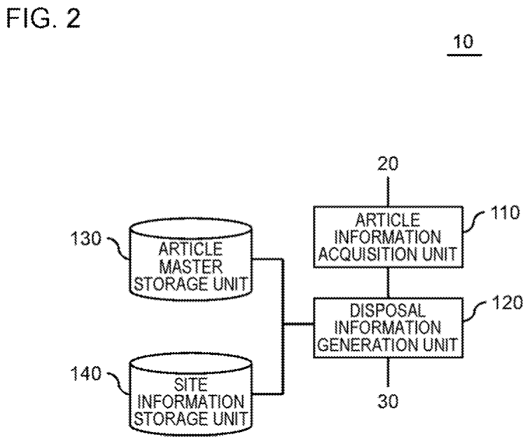

FIG. 2 is a diagram illustrating one example of a functional configuration of the disposal information generation apparatus 10. In the example illustrated in FIG. 2, the disposal information generation apparatus 10 includes an article information acquisition unit 110 and a disposal information generation unit 120. The article information acquisition unit 110 acquires the above-described article information. The disposal information generation unit 120 generates the above-described disposal information by using the article information and outputs the generated disposal information.

In the example illustrated in FIG. 2, an article is a product sold in the store 40. Further, the disposal information generation unit 120 generates disposal information by using an article master storage unit 130 and a site information storage unit 140 in addition to article information. The article master storage unit 130 stores information (hereinafter, described as product information) relating to a product sold in the store 40. The product information stores at least an attribute of waste (e.g., raw garbage, burnable waste, non-burnable garbage, plastic trash, and the like) coming out of the product. The site information storage unit 140 associates an attribute of waste with a site (hereinafter, described as a disposal site) where an article having the attribute is to be disposed of. Further, the disposal information generation unit 120 determines an attribute of a target article (product) as waste by using the article master storage unit 130, reads a disposal site associated with the attribute from the site information storage unit 140, and generates disposal information in such a way as to include information indicating the read disposal site. Note that, an example of a data structure of the article master storage unit 130 and the site information storage unit 140 is described later by using another drawing.

In the example illustrated in FIG. 2, the article master storage unit 130 and the site information storage unit 140 become part of the disposal information generation apparatus 10. However, the article master storage unit 130 and the site information storage unit 140 may be provided outside the disposal information generation apparatus 10. Further, the article information acquisition unit 110 and the disposal information generation unit 120 may be achieved by mutually different pieces of hardware.

Further, in a case where there are a plurality of the stores 40, the disposal information generation apparatus 10 stores information (hereinafter, store identification information) for identifying the store 40, and position information of the store 40 in association with each other. Further, the article master storage unit 130 may be provided for each of the plurality of the stores 40, or may be shared among the plurality of the stores 40.

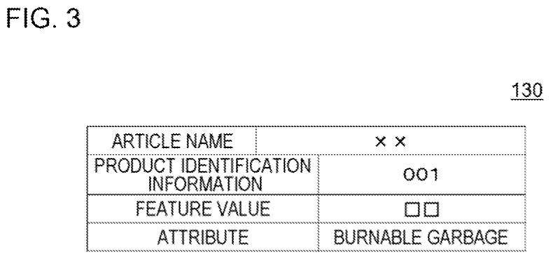

FIG. 3 is a diagram illustrating one example of data structure of the article master storage unit 130. In the example illustrated in FIG. 3, the article master storage unit 130 stores information serving as a product master. The product master stores, for each article (product), a name of the product, product identification information (e.g., code information assigned to the product), a feature value of an external appearance of the product, and an attribute of the product as garbage. The feature value of the external appearance includes at least one of a shape, color, and a size. The product identification information is identification information uniquely assigned to the product, and may be defined for each store 40, or may be standardized identification information (e.g., a JAN code or an EAN code).

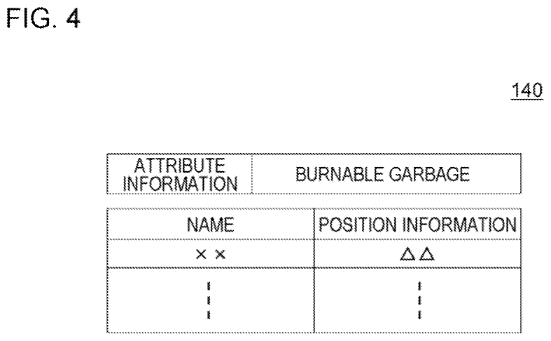

FIG. 4 is a diagram illustrating one example of data structure of the site information storage unit 140. In the example illustrated in FIG. 4, the site information storage unit 140 stores a name of a disposal site where waste is to be disposed of, and position information, for each attribute of the waste. The disposal site is, for example, a site where a garbage can is installed. Further, the name of the disposal site may be a name of a facility where a garbage can is installed. Note that, a name may not be given to a disposal site. In this case, a name column has a blank. Further, the position information includes, for example, at least either of an address, and latitude and longitude information.

In the example illustrated in FIG. 4, the site information storage unit 140 stores information relating to a plurality of disposal sites with respect to one attribute. Further, the disposal information generation unit 120 narrows down to at least one disposal site from among these plurality of disposal sites. When performing narrowing-down, the site information storage unit 140 uses position information on each of the store 40 and the disposal site. Details on the processing are described later by using a flowchart.

Note that, the site information storage unit 140 may store information describing a disposal method of waste, and/or a URL for displaying the information, in place of a name and position information of a disposal site. In this case, the disposal information includes information describing a disposal method and/or the above-described URL, in place of information indicating a disposal site.

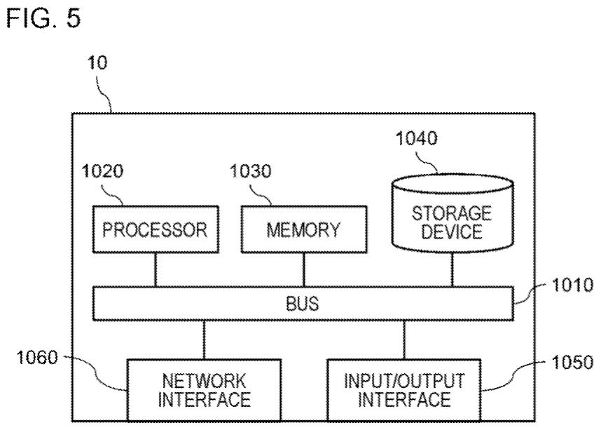

FIG. 5 is a diagram illustrating a hardware configuration example of the disposal information generation apparatus 10. The disposal information generation apparatus 10 includes a bus 1010, a processor 1020, a memory 1030, a storage device 1040, an input/output interface 1050, and a network interface 1060.

The bus 1010 is a data transmission path along which the processor 1020, the memory 1030, the storage device 1040, the input/output interface 1050, and the network interface 1060 mutually transmit and receive data. However, a method of mutually connecting the processor 1020 and the like is not limited to bus connection.

The processor 1020 is a processor to be achieved by a central processing unit (CPU), a graphics processing unit (GPU), or the like.

The memory 1030 is a main storage to be achieved by a random access memory (RAM) or the like.

The storage device 1040 is an auxiliary storage to be achieved by a hard disk drive (HDD), a solid state drive (SSD), a memory card, a read only memory (ROM), or the like. The storage device 1040 stores a program module achieving each function (e.g., the article information acquisition unit 110, and the disposal information generation unit 120) of the disposal information generation apparatus 10. The processor 1020 achieves each function associated with each program module by reading the program module in the memory 1030 and executing the program module. Further, the storage device 1040 also functions as the article master storage unit 130 and the site information storage unit 140.

The input/output interface 1050 is an interface for connecting the disposal information generation apparatus 10 and various pieces of input/output equipment with each other.

The network interface 1060 is an interface for connecting the disposal information generation apparatus 10 to a network. The network is, for example, a local area network (LAN) or a wide area network (WAN). A method of connecting the network interface 1060 to the network may be wireless connection, or may be wired connection. The disposal information generation apparatus 10 communicates with the sensor 20 and the display apparatus 30 via the network interface 1060.

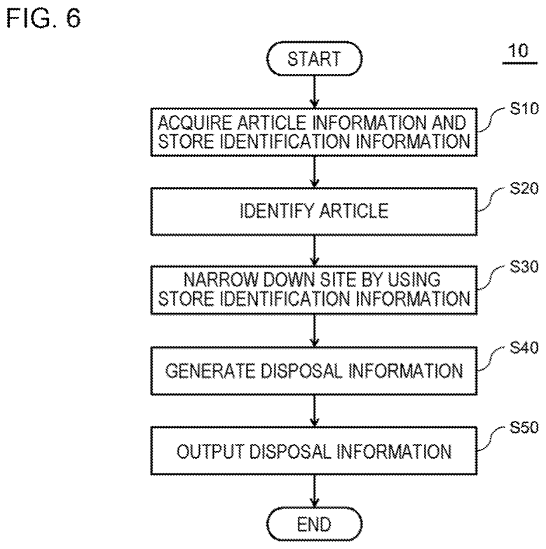

FIG. 6 is a diagram illustrating one example of processing to be performed by the disposal information generation apparatus 10. In the store 40, a product to be purchased by a customer is placed on a site where payment is performed (e.g., a site where a payment apparatus or a cash register is installed). Then, an imaging apparatus included in the sensor 20 generates an image including the product. Further, a communication apparatus installed in the store 40 transmits the generated image to the disposal information generation apparatus 10. At this occasion, the communication apparatus also transmits store identification information of the store 40 to the disposal information generation apparatus 10.

The article information acquisition unit 110 of the disposal information generation apparatus 10 acquires the image and the store identification information transmitted from the store 40. The article information acquisition unit 110 generates a feature value of an external appearance of the product by acquiring the image, and processing the image. The feature value becomes at least a part of article information.

Note that, processing of generating a feature value of an external appearance of a product may be performed by an image processing apparatus installed in the store 40. In this case, the communication apparatus transmits the feature value to the disposal information generation apparatus 10, in place of the image.

Subsequently, the disposal information generation unit 120 identifies the product that is intended to be purchased (or purchased) by the customer in the store 40 by using the feature value of the external appearance of the product, and a feature value of each product stored in the article master storage unit 130 (step S20).

Subsequently, the disposal information generation unit 120 reads, from the product master storage unit 130, an attribute of waste associated with the product.

Note that, in a case where the sensor 20 includes an odor sensor and a sound sensor, in addition to the imaging apparatus, article information also includes, in addition to an image (or a feature value generated from an image), odor information and sound information. In this case, the disposal information generation unit 120 may estimate an attribute of an article as waste by processing the image, the odor information, and the sound information. In this case, the disposal information generation unit 120 may also use, for example, a model generated by machine learning. The model outputs an attribute as waste, when, for example, an image (or a feature value of an external appearance of an article), odor information, and sound information are input.

Then, the disposal information generation unit 120 reads, from the site information storage unit 140, a plurality of disposal sites associated with the attribute of the product. Further, the disposal information generation unit 120 identifies an address (specifically, an address of the store 40) associated with the store identification information acquired in step S10. Then, the disposal information generation unit 120 selects, from among the plurality of read disposal sites, a disposal site near the store 40 (step S30), and generates disposal information by using position information of the selected disposal site (step S40). The disposal information may be such that a position (e.g., an address) of a disposal site is indicated by text data, or a disposal site is indicated on a map.

Note that, when selecting a disposal site that should be included in disposal information, the disposal information generation unit 120 may determine a route through which a person who goes out of the store 40 is highly likely to pass, and select a disposal site on the route, or a disposal site near the route.

Thereafter, the disposal information generation unit 120 transmits the disposal information to the display apparatus 30 (step S50). The display apparatus 30 displays the disposal information acquired from the disposal information generation unit 120. In the store 40, a customer who purchased a product can recognize a site where the product or waste (e.g., garbage) coming out of the product should be disposed of, by checking disposal information displayed on the display apparatus 30.

In this way, according to the present example embodiment, it is possible to notify a person (e.g., a customer who purchased a product) who wishes to dispose of an article, of a disposal site according to the article.

### First Modification Example

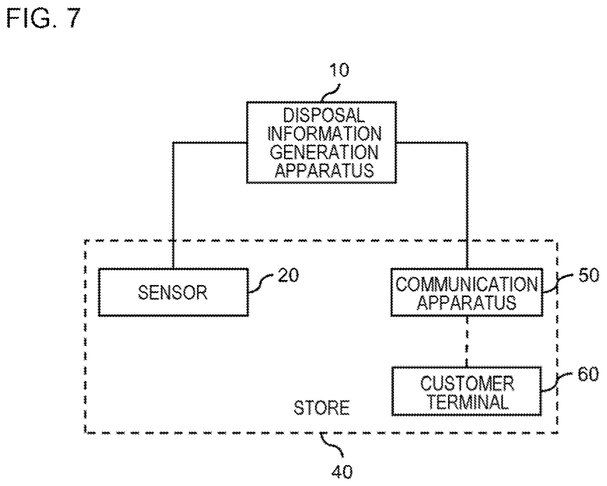

FIG. 7 is a diagram illustrating a usage environment of a disposal information generation apparatus 10 according to a present modification example. In the example illustrated in FIG. 7, disposal information is similar to that in the above-described example embodiment except for a point that disposal information is transmitted to a customer terminal 60, in place of a display apparatus 30.

More specifically, the customer terminal 60 is a mobile terminal held by a customer, and communicates with the disposal information generation apparatus via a communication apparatus 50 installed in a store 40. The communication apparatus 50 is placed, for example, near a site where payment for products is performed, and performs short-range wireless communication with the customer terminal 60. A standard for the short-range wireless communication is, for example, Wi-Fi (registered trademark) or Bluetooth (registered trademark), but is not limited thereto.

Application software is installed in advance in the customer terminal 60, and the customer terminal 60 communicates with the disposal information generation apparatus 10 via the communication apparatus 50 by using the software. For example, when the customer terminal 60 enters a communication range of the communication apparatus 50, the customer terminal 60 is connected to the communication apparatus 50. Then, when receiving disposal information from the disposal information generation apparatus 10, the communication apparatus 50 transmits the received disposal information to the customer terminal 60. Further, the customer terminal 60 displays and stores the disposal information.

Note that, the disposal information generation apparatus 10 may not transmit disposal information first, but may transmit a URL for accessing to the disposal information. In this case, the customer terminal 60 receives the URL, and when the URL is selected, the customer terminal 60 acquires the disposal information by using the URL.

According to the present modification example, since the customer terminal 60 stores disposal information, a customer can check the disposal information also outside the store 40.

### Second Modification Example

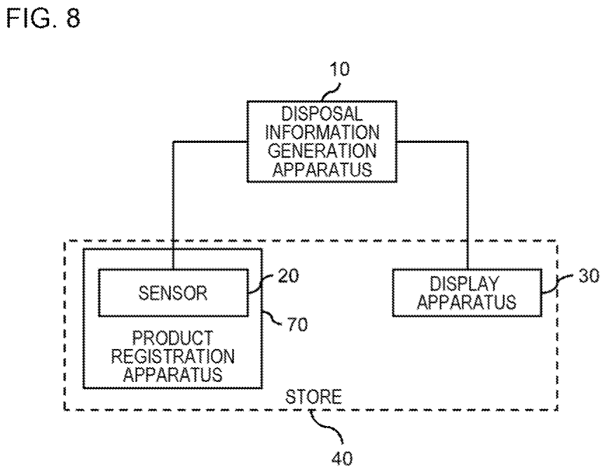

FIG. 8 is a diagram illustrating a usage environment of a disposal information generation apparatus 10 according to a present modification example. The present modification example is similar to the example embodiment or the modification example described above except for the following point.

First, a sensor 20 is a code reader provided in a product registration apparatus 70, and reads a code (e.g., a barcode or a two-dimensional code) attached to a product for registering the product to be paid for. The code includes product identification information. Further, the sensor 20 transmits, to the disposal information generation apparatus 10, the product identification information (or code information itself), as article information.

Further, a disposal information generation unit 120 of the disposal information generation apparatus 10 identifies the product by using the product identification information acquired from the sensor 20.

Also, according to the present modification example, it is possible to notify a customer who purchased a product, of a disposal site according to the product.

### Third Modification Example

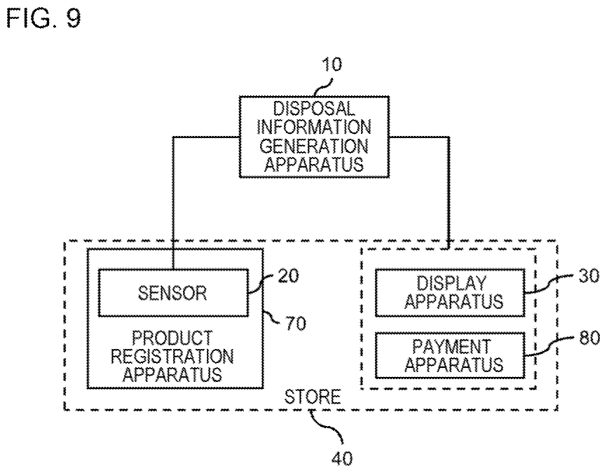

FIG. 9 is a diagram illustrating a usage environment of a disposal information generation apparatus 10 according to a present modification example. The present modification example is similar to the above-described second modification example except for the following point.

First, the disposal information generation apparatus 10 transmits disposal information to a payment apparatus 80, as well as to a display apparatus 30. The payment apparatus 80 is an apparatus that performs payment processing of a purchased product, and generates and outputs receipt information. The payment apparatus 80 allows the receipt information to include disposal information.

Note that, the payment apparatus 80 may print and output receipt information on paper, or may output receipt information, as an electronic receipt, to an external apparatus (e.g., a customer terminal or a server). Further, in the example illustrated in FIG. 9, the payment apparatus 80 is configured as an apparatus different from a product registration apparatus 70, but may be configured integrally with the product registration apparatus 70.

According to the present modification example, the payment apparatus 80 allows receipt information to include disposal information. Therefore, a customer can check the disposal information also outside a store 40.

### Fourth Modification Example

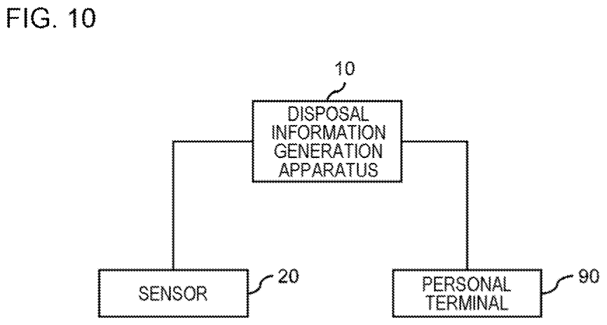

FIG. 10 is a diagram illustrating a usage environment of a disposal information generation apparatus 10 according to a present modification example. In the example illustrated in FIG. 10, a position of a sensor 20 is not limited to the inside of a store 40. Further, processing to be performed by the disposal information generation apparatus 10 is similar to that of the example embodiment or the modification examples described above except for the following point.

First, the disposal information generation apparatus 10 communicates with a personal terminal 90. The personal terminal 90 is a terminal held by a person who intends to dispose of an article, and stores attribute information (hereinafter, described as personal attribute information) of the person. The personal terminal 90 transmits personal attribute information to the disposal information generation apparatus 10 before disposal information is generated. Further, the disposal information generation apparatus 10 generates disposal information by using the personal attribute information.

The personal attribute information includes at least either a residential area (or an address) of the person, or a current position of the person. Further, in a case where a holder of the personal terminal 90 is a cleaning staff, the personal attribute information includes information indicating an area for which the cleaning staff is responsible for. The residential area (or the address) and the responsible area are stored in advance in the personal terminal 90. Further, the current position is generated by using a GPS function loaded in the personal terminal 90. Further, a disposal information generation unit 120 of the disposal information generation apparatus 10 selects a disposal site to be included in disposal information by using the personal attribute information. For example, the disposal information generation unit 120 estimates a route from a current position of the person to a residential area, and selects a disposal site on the route, or a disposal site being easily accessible from the route. Note that, the disposal information generation unit 120 may select a disposal site near the residential area or the current position. Further, in a case where the personal attribute information includes the area for which the cleaning staff is responsible for, the disposal information generation unit 120 selects a disposal site near the area for which the cleaning staff is responsible for.

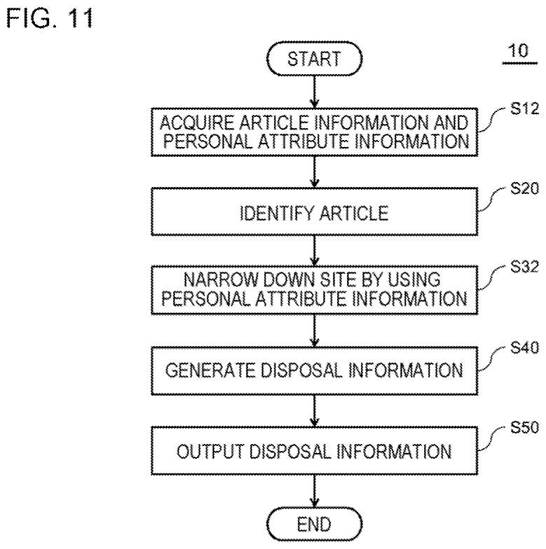

FIG. 11 is a flowchart illustrating one example of an operation of the disposal information generation apparatus 10 according to the present modification example.

First, a person who intends to dispose of an article approaches the sensor and transmits personal attribute information to the disposal information generation apparatus 10 by operating the personal terminal 90. The sensor 20 generates article information of an article carried nearby the sensor 20 by the person, and transmits the generated article information to the disposal information generation apparatus 10 (step S12).

Subsequently, the disposal information generation unit 120 identifies the article (step S20). Details on the processing are similar to those in the above-described example embodiment.

Subsequently, the disposal information generation unit 120 reads, from an article master storage unit 130, an attribute of waste associated with the product. Then, the disposal information generation unit 120 reads, from a site information storage unit 140, a plurality of disposal sites associated with the read attribute. Subsequently, the disposal information generation unit 120 selects, by using the personal attribute information, a disposal site to be included in disposal information from among the plurality of disposal sites read from the site information storage unit 140 (step S32). Pieces of processing (steps S40 and S50) thereafter are similar to those in the example embodiment.

According to the present modification example, it is possible to notify a person who wishes to dispose of an article, of a disposal site according to the article and an attribute of the person.

### Second Example Embodiment

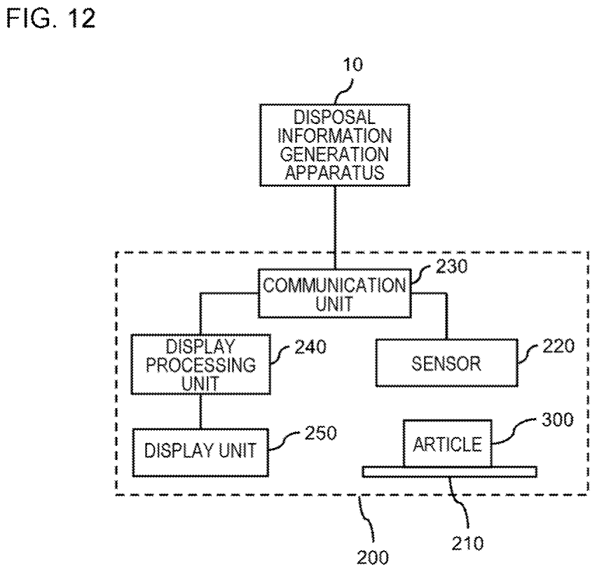

FIG. 12 is a diagram illustrating a usage environment of a disposal information generation apparatus 10 according to a present example embodiment. In the example illustrated in FIG. 12, the disposal information generation apparatus 10 is used together with an article information generation apparatus 200. The article information generation apparatus 200 is installed, for example, in town, generates article information, and also displays disposal information generated by the disposal information generation apparatus 10.

More specifically, the article information generation apparatus 200 includes a placement table 210, a sensor 220, a communication unit 230, a display processing unit 240, and a display unit 250.

The placement table 210 includes an area where an article to be disposed of is placed.

The sensor 220 generates article information relating to an article placed on the placement table 210. The sensor 220 includes at least an imaging apparatus, an odor sensor, and a sound sensor. The imaging apparatus generates an image including the article. The odor sensor generates information (hereinafter, described as odor information) indicating odor of the article. The sound sensor generates information (hereinafter, described as sound information) indicating a sound when the article is placed on the placement table 210. Further, the article information includes the image, the odor information, and the sound information. The communication unit 230 transmits, to the disposal information generation apparatus 10, the article information together with identification information of the article information generation apparatus 200. The disposal information generation apparatus 10 stores position information of the article information generation apparatus 200 in association with the identification information of the article information generation apparatus 200. Further, the identification information of the article information generation apparatus 200 is used, in place of store identification information in the first example embodiment.

Further, a disposal information generation unit 120 of the disposal information generation apparatus 10 determines an attribute of the article as waste by processing the image, the odor information, and the sound information. In this case, the disposal information generation unit 120 may also use, for example, a model generated by machine learning. The model outputs an attribute as waste, when, for example, an image (or a feature value of an external appearance of an article), odor information, and sound information are input. The disposal information generation unit 120 generates disposal information by using the attribute. Details on the processing to be performed herein are similar to those of the first example embodiment or the modification examples thereof. Further, the disposal information generation unit 120 of the disposal information generation apparatus 10 transmits the disposal information to the article information generation apparatus 200.

The communication unit 230 of the article information generation apparatus 200 acquires the disposal information from the disposal information generation apparatus 10. Further, the display processing unit 240 performs processing for causing the display unit 250 to display the disposal information acquired by the communication unit 230. Further, a person who intends to dispose of waste recognizes a site where the waste is to be disposed of, by viewing information displayed on the display unit 250.

Also, according to the present example embodiment, it is possible to notify a person who wishes to dispose of an article, of a disposal site according to the article.

### Modification Example

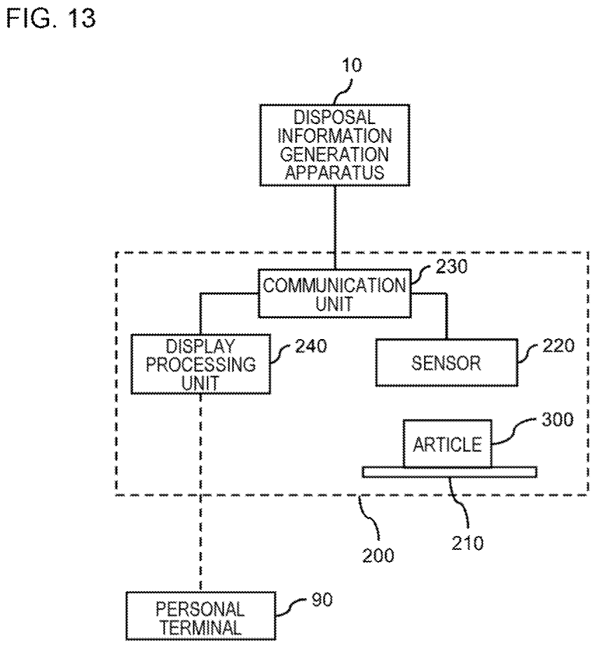

FIG. 13 is a diagram illustrating a modification example in FIG. 12. In the example illustrated in FIG. 13, a display processing unit 240 communicates with a personal terminal 90, and causes the personal terminal 90 to display disposal information. The display processing unit 240 and the personal terminal 90 are connected by using, for example, short-range wireless communication. A standard for the short-range wireless communication to be used herein is, for example, Wi-Fi (registered trademark) or Bluetooth (registered trademark), but is not limited thereto.

Note that, in the present modification example, the personal terminal 90 may transmit personal attribute information to a disposal information generation apparatus 10, similarly to the fourth modification example of the first example embodiment. In this case, the disposal information generation apparatus 10 generates disposal information by using the personal attribute information, similarly to the fourth modification example of the first example embodiment.

Also, according to the present example embodiment, it is possible to notify a person who wishes to dispose of an article, of a disposal site according to the article. Further, since disposal information can be stored in the personal terminal 90, a person who wishes to dispose of waste can check disposal information even away from the article information generation apparatus 200.

As described above, while the example embodiments according to the present invention have been described with reference to the drawings, these are an example of the present invention, and various configurations other than the above can also be adopted.

Further, in a plurality of flowcharts used in the above description, a plurality of steps (pieces of processing) are described in order, but an order of execution of steps to be performed in each example embodiment is not limited to the order of description. In each example embodiment, the order of illustrated steps can be changed within a range that does not adversely affect a content. Further, the above-described example embodiments can be combined, as far as contents do not conflict with each other.

A part or all of the above-described example embodiments may also be described as the following supplementary notes, but is not limited to the following.
1. A disposal information generation apparatus including:
   an article information acquisition unit that acquires article information being information generated by using a sensor, and being information relating to an article; and
   a disposal information generation unit that generates and outputs disposal information being information relating to a site where the article or waste coming out of the article is to be disposed of, by using the article information.
2. The disposal information generation apparatus according to supplementary note 1, in which
   the disposal information generation unit generates the disposal information by using disposal site information in which an attribute of the article and a site where an article having the attribute is to be disposed of are associated with each other.
3. The disposal information generation apparatus according to supplementary note 1 or 2, in which
   the article information acquisition unit acquires personal attribute information indicating an attribute of a person who disposes of the article, and
   the disposal information generation unit generates the disposal information by using the personal attribute information.
4. The disposal information generation apparatus according to supplementary note 3, in which
   the personal attribute information includes at least one of a current position of the person, a residence position of the person, and an area for which the person being a cleaning staff is responsible for.
5. The disposal information generation apparatus according to any one of supplementary notes 1 to 4, in which
   the article is a product sold in a store, and
   the article information includes product identification information for identifying the product.
6. The disposal information generation apparatus according to any one of supplementary notes 1 to 5, in which
   the sensor includes an imaging apparatus.
7. The disposal information generation apparatus according to supplementary note 6, in which
   the article is a product sold in a store, and
   the imaging apparatus captures an image of an inside of the store.
8. The disposal information generation apparatus according to supplementary note 5 or 7, in which
   the disposal information generation unit outputs the disposal information to a display apparatus installed in the store.
9. The disposal information generation apparatus according to any one of supplementary notes 5, 7, and 8, in which
   the disposal information generation unit allows receipt information generated when the product is sold to include the disposal information.
10. The disposal information generation apparatus according to any one of supplementary notes 5, 7, 8, and 9, in which
   the disposal information generation unit outputs the disposal information to a terminal of a customer who purchased the product.
11. The disposal information generation apparatus according to any one of supplementary notes 1 to 10, in which
   the sensor includes at least one of an odor sensor and a sound sensor.
12. An article information generation apparatus being used together with the disposal information generation apparatus according to any one of supplementary notes 1 to 11, including:
   a sensor that generates the article information of the article placed in a predetermined area; and
   a communication unit that transmits the article information to the disposal information generation apparatus.
13. The article information generation apparatus according to supplementary note 12, in which
   the communication unit acquires the disposal information from the disposal information generation apparatus,
   the article information generation apparatus further including
   a display processing unit that performs processing for causing a display unit to display the disposal information.
14. A disposal information generation method including,
   by a computer:
   article information acquisition processing of acquiring article information being information generated by using a sensor, and being information relating to an article; and
   disposal information generation processing of generating and outputting disposal information being information relating to a site where the article or waste coming out of the article is to be disposed of, by using the article information.
15. The disposal information generation method according to supplementary note 14, in which
   by the computer,
   in the disposal information generation processing, the disposal information is generated by using disposal site information in which an attribute of the article and a site where an article having the attribute is to be disposed of are associated with each other.
16. The disposal information generation method according to supplementary note 14 or 15, in which
   by the computer,
   in the article information acquisition processing, personal attribute information indicating an attribute of a person who disposes of the article is acquired, and,
   in the disposal information generation processing, the disposal information is generated by using the personal attribute information.
17. The disposal information generation method according to supplementary note 16, in which
   the personal attribute information includes at least one of a current position of the person, a residence position of the person, and an area for which the person being a cleaning staff is responsible for.
18. The disposal information generation method according to any one of supplementary notes 14 to 17, in which
   the article is a product sold in a store, and
   the article information includes product identification information for identifying the product.
19. The disposal information generation method according to any one of supplementary notes 14 to 18, in which
   the sensor includes an imaging apparatus.
The disposal information generation method according to supplementary note 19, in which
   the article is a product sold in a store, and
   the imaging apparatus captures an image of an inside of the store.
21. The disposal information generation method according to supplementary note 18 or 20, in which
   by the computer,
   in the disposal information generation processing, the disposal information is output to a display apparatus installed in the store.
22. The disposal information generation method according to any one of supplementary notes 18, 20, and 21, in which
   by the computer,
   in the disposal information generation processing, receipt information generated when the product is sold is allowed to include the disposal information.
23. The disposal information generation method according to any one of supplementary notes 18, 20, 21, and 22, in which
   by the computer,
   in the disposal information generation processing, the disposal information is output to a terminal of a customer who purchased the product.
24. The disposal information generation method according to any one of supplementary notes 14 to 23, in which
   the sensor includes at least one of an odor sensor and a sound sensor.
25. A program causing a computer to include:
   an article information acquisition function of acquiring article information being information generated by using a sensor, and being information relating to an article; and
   a disposal information generation function of generating and outputting disposal information being information relating to a site where the article or waste coming out of the article is to be disposed of, by using the article information.
26. The program according to supplementary note 25, in which
   the disposal information generation function generates the disposal information by using disposal site information in which an attribute of the article and a site where an article having the attribute is to be disposed of are associated with each other.
27. The program according to supplementary note 25 or 26, in which
   the article information acquisition function acquires personal attribute information indicating an attribute of a person who disposes of the article, and
   the disposal information generation function generates the disposal information by using the personal attribute information.
28. The program according to supplementary note 27, in which
   the personal attribute information includes at least one of a current position of the person, a residence position of the person, and an area for which the person being a cleaning staff is responsible for.
29. The program according to any one of supplementary notes 25 to 28, in which
   the article is a product sold in a store, and
   the article information includes product identification information for identifying the product.
30. The program according to any one of supplementary notes 25 to 29, in which
   the sensor includes an imaging apparatus.
31. The program according to supplementary note 30, in which
   the article is a product sold in a store, and
   the imaging apparatus captures an image of an inside of the store.
32. The program according to supplementary note 29 or 31, in which
   the disposal information generation function outputs the disposal information to a display apparatus installed in the store.
33. The program according to any one of supplementary notes 29, 31, and 32, in which
   the disposal information generation function allows receipt information generated when the product is sold to include the disposal information.
34. The program according to any one of supplementary notes 29, 31, 32, and
33, in which
   the disposal information generation function outputs the disposal information to a terminal of a customer who purchased the product.
35. The program according to any one of supplementary notes 25 to 34, in which the sensor includes at least one of an odor sensor and a sound sensor.

### REFERENCE SIGNS LIST

10 Disposal information generation apparatus
20 Sensor
30 Display apparatus
40 Store
50 Communication apparatus
60 Customer terminal
70 Article registration apparatus
80 Payment apparatus
90 Personal terminal
110 Article information acquisition unit
120 Disposal information generation unit
130 Article master storage unit
140 Site information storage unit
200 Article information generation apparatus
210 Placement table
220 Sensor
230 Communication unit
240 Display processing unit
250 Display unit

What is claimed is:

1. A disposal information generation apparatus comprising:
at least one memory configured to store instructions; and
at least one processor configured to execute the instructions to perform operations, the operations comprising:
acquiring article information being information generated by using a sensor, and being information relating to an article; and
generating and outputs disposal information being information relating to a site where the article or waste coming out of the article is to be disposed of, by using the article information.

2. The disposal information generation apparatus according to claim 1, wherein
the operations comprise generating the disposal information by using disposal site information in which an attribute of the article and a site where an article having the attribute is to be disposed of are associated with each other.

3. The disposal information generation apparatus according to claim 1, wherein the operations comprise
acquiring personal attribute information indicating an attribute of a person who disposes of the article, and
generating the disposal information by using the personal attribute information.

4. The disposal information generation apparatus according to claim 3, wherein
the personal attribute information includes at least one of a current position of the person, a residence position of the person, and an area for which the person being a cleaning staff is responsible for.

5. The disposal information generation apparatus according to claim 1, wherein
the article is a product sold in a store, and
the article information includes product identification information for identifying the product.

6. The disposal information generation apparatus according to claim 1, wherein
the sensor includes an imaging apparatus.

7. The disposal information generation apparatus according to claim 6, wherein
the article is a product sold in a store, and
the imaging apparatus captures an image of an inside of the store.

8. The disposal information generation apparatus according to claim 5, wherein
the operations comprise outputting the disposal information to a display apparatus installed in the store.

9. The disposal information generation apparatus according to claim 5, wherein
the operations comprise allowing receipt information generated when the product is sold to include the disposal information.

10. The disposal information generation apparatus according to claim 5, wherein
the operations comprise outputting the disposal information to a terminal of a customer who purchased the product.

11. The disposal information generation apparatus according to claim 1, wherein
the sensor includes at least one of an odor sensor and a sound sensor.

12-13. (canceled)

14. A disposal information generation method comprising,
by a computer:
acquiring article information being information generated by using a sensor, and being information relating to an article; and
generating and outputting disposal information being information relating to a site where the article or waste coming out of the article is to be disposed of, by using the article information.

15. A non-transitory computer-readable medium storing a program causing a computer to perform operations, the operations comprising:
acquiring article information being information generated by using a sensor, and being information relating to an article; and
generating and outputting disposal information being information relating to a site where the article or waste coming out of the article is to be disposed of, by using the article information.
